(19) United States
(12) Patent Application Publication
(10) Pub. No.: US 2024/0231882 A9
(43) Pub. Date: Jul. 11, 2024

(54) METHOD AND APPARATUS FOR LIVE MIGRATION OF VIRTUAL MACHINE

(71) Applicant: MONTAGE TECHNOLOGY (KUNSHAN) CO., LTD., Suzhou, Jiangsu (CN)

(72) Inventors: Yu CAI, Suzhou (CN); Chunhui ZHANG, Suzhou (CN)

(73) Assignee: MONTAGE TECHNOLOGY (KUNSHAN) CO., LTD., Suzhou, Jiangsu (CN)

(21) Appl. No.: 18/278,433

(22) PCT Filed: May 20, 2021
(86) PCT No.: PCT/CN2021/094935

§ 371 Date: Aug. 23, 2023

(30) Foreign Application Priority Data
Feb. 23, 2021 (CN) 202110204159.5

(51) Int. Cl. G06F 9/455

(52) U.S. Cl. CPC G06F 9/45558; G06F 2009/4557

(57) ABSTRACT

The present application relates to the technical field of computers. Provided are a method and apparatus for live migration of a virtual machine. The method comprises: when executing, in a virtual machine module on a destination host, an instruction of an instruction set that the destination host does not have but a source host has, trapping an exception; a system virtualization module intercepting the exception, and parsing an interrupt context of the exception; according to instruction address information of the interrupt context, acquiring data of the instruction, and decoding the same; and emulating an execution process of the instruction on the basis of the instruction set of the destination host. By means of the present application, the live migration of a virtual machine of cross-generation processors can be realized, while a higher instruction set capability is maintained.

### TECHNICAL FIELD

This application relates to the technology field of computers, and in particular to a method and an apparatus for live migration of a virtual machine.

### BACKGROUND

The main reason for the current widespread issues of virtual machine live migration failure in data centers is that the data centers often deploy processors with incompatible instruction sets, such as Intel's Broadwell processor and Skylake processor. Although these two processors both belong to X86 architecture, the Skylake processor has the latest AVX512 instruction set, while the Broadwell processor does not have the AVX512 instruction set, which usually causes the virtual machine created on a source node based on the Skylake processor to fail to migrate to a target node based on the Broadwell processor.

In general, there are three models to create a virtual machine using libvirt/QEMU/KVM stack: host-passthrough mode, host-model mode, and custom-model mode, which correspond to virtual machines with sequentially lower performance but sequentially higher live migration compatibility. In order to ensure sufficient performance and take into account the live migration compatibility, the deployment of the data centers usually selects virtual machines in the host-model mode. In this mode, the instruction sets exposed to the virtual machine are often less than the instruction sets possessed by the host. Although certain differences are allowed between the target node processor and the source node processor, the allowed differences cannot cover the AVX512 instruction set, so the live migration will still fail.

Therefore, it is necessary to provide a method for live migration of a virtual machine across different generation processors that retain higher instruction set capabilities.

### SUMMARY OF THE INVENTION

An object of this application is to provide a method for live migration of a virtual machine to realize the live migration of virtual machine across different generation processors.

A method for live migration of a virtual machine is disclosed in an embodiment of this application, including:
trapping an exception when an instruction of an instruction set that is not possessed by a destination host but possessed by a source host is executed in a virtual machine on the destination host;
intercepting the exception and analyzing an interrupt context of the exception by a kernel-based virtual machine module in the destination host;
acquiring and decoding data of the instruction according to instruction address information of the interrupt context; and
emulating an execution process of the instruction by using an instruction set possessed by the destination host.

According to an embodiment of this application, the method also includes: creating a processor feature map in the destination host according to the emulation results;
creating a virtual machine on the source host based on the processor feature map; and
live-migrating the virtual machine on the source host to the destination host.

According to an embodiment of this application, the step of emulating the execution process of the instruction by using the instruction set of the destination host, further comprising:
emulating a process of decoding the instruction by using a decoding tool, generating emulation instruction(s), and establishing a test case library; and
transplanting the emulation instructions to the kernel-based virtual machine module in the destination host, and performing regression test on the test case library.

According to an embodiment of this application, the source host is a higher-generation processor than the destination host.

According to an embodiment of this application, the instruction set possessed by the destination host is AVX2, the instruction set possessed by the source host is AVX512.

An apparatus for the live migration of a virtual machine is disclosed in another embodiment of this application, including:
a trap unit, configured to trap an exception when an instruction of an instruction set that is not possessed by a destination host but possessed by a source host is executed in the virtual machine on the destination host;
an interception unit, set in a kernel-based virtual machine module in the destination host, and configured to intercept the exception and analyze an interrupt context of the exception;
a decoding unit, configured to acquire and decode data of the instruction according to instruction address information of the interrupt context; and
an emulation unit, configured to emulate an execution process of the instruction by using an instruction set possessed by the destination host.

According to an embodiment of this application, the apparatus also includes:
a creation unit, configured to create a processor feature map in the destination host according to the emulation results, and create a virtual machine on the source host based on the processor feature map; and
a migration unit, configured to live-migrate the virtual machine on the source host to the destination.

According to an embodiment of this application, when performing the step of emulating the execution process of the instruction by using the instruction set of the destination host, the emulation unit is further configured to:
emulate a process of decoding the instruction by using a decoding tool, generate emulation instruction(s), and establish a test case library; and
transplant the emulation instructions to the kernel-based virtual machine module in the destination host, and perform regression test on the test case library.

According to an embodiment of this application, the source host is a higher-generation processor than the destination host.

According to an embodiment of this application, the instruction set possessed by the destination host is AVX2, the instruction set possessed by the source host is AVX512.

The present application can realize the live migration of the virtual machine across different generation processors, which can retain higher instruction set capabilities and slow down the period of server obsolescence in data centers to a certain extent, thereby reducing the cost of the server deployment.

A large number of technical features are described in the specification of the present application, and are distributed in various technical solutions. If a combination (i.e., a technical solution) of all possible technical features of the present application is listed, the description may be made too long. In order to avoid this problem, the various technical features disclosed in the above summary of the present application, the technical features disclosed in the various embodiments and examples below, and the various technical features disclosed in the drawings can be freely combined with each other to constitute various new technical solutions (all of which are considered to have been described in this specification), unless a combination of such technical features is not technically feasible. For example, feature A+B+C is disclosed in one example, and feature A+B+D+E is disclosed in another example, while features C and D are equivalent technical means that perform the same function, and technically only choose one, not to adopt at the same time. Feature E can be combined with feature C technically. Then, the A+B+C+D scheme should not be regarded as already recorded because of the technical infeasibility, and A+B+C+E scheme should be considered as already documented.

### BRIEF DESCRIPTION OF THE FIGURES

FIG. 1 is a flowchart of a method for live migration of a virtual machine in an embodiment of this application.

FIG. 2 is a schematic diagram of an emulation process of an instruction set during live migration of a virtual machine in an embodiment of this application.

FIG. 3 is a schematic diagram of an apparatus for live migration of a virtual migration in an embodiment of this application.

### DETAILED DESCRIPTION

In the following description, numerous technical details are set forth in order to provide the readers with a better understanding of the present application. However, those skilled in the art can understand that the technical solutions claimed in the present application can be implemented without these technical details and various changes and modifications based on the following embodiments.

Explanation of some concepts:
Kernel-based Virtual Machine (KVM) is an open-source system virtualization module, which is integrated in various major distribution versions of Linux.

Instruction set is a set of instructions used to calculate and control the computer system in the CPU, and each new type of CPU specifies a series of instruction systems that cooperate with other hardware circuits when it is designed. Whether the instruction set is advanced or not is also related to the performance of the CPU. It is also an important symbol of the CPU performance.

Virtual Machine (VM): refers to a complete computer system that is emulated by software and has a complete hardware system function that runs in a completely isolated environment. Everything that can be done on a physical computer can be achieved on the virtual machine.

Live migration: also known as dynamic migration and real-time migration, that is, the preservation/recovery of the virtual machine. The live migration usually saves the running state of the entire virtual machine and at the same time can quickly restore to the original hardware platform or even a different hardware platform. After recovery, the virtual machine is still running smoothly, and users will not notice any differences.

In order to make the objects, technical solutions and advantages of the present application more clearer, embodiments of the present application will be further described in detail below with reference to the accompanying drawings.

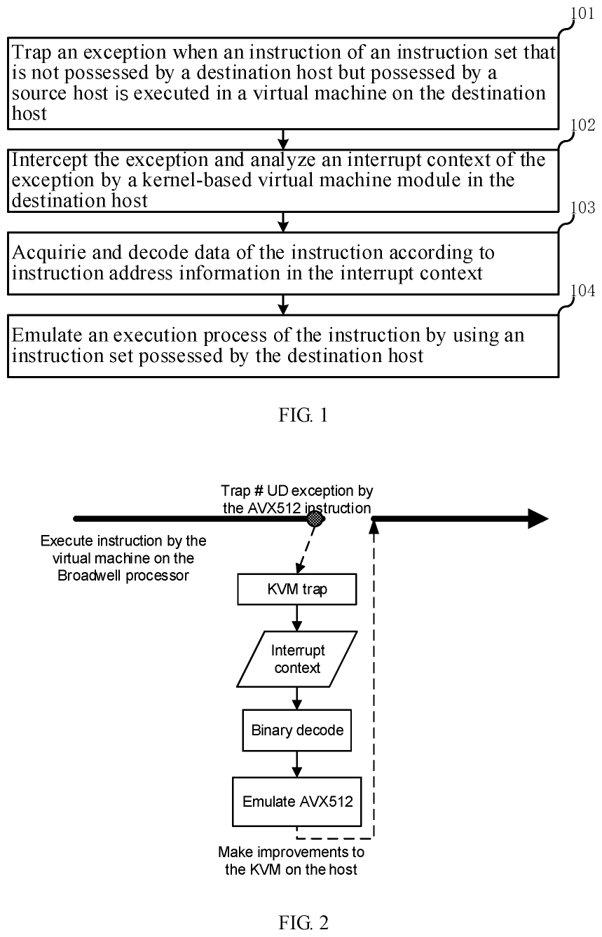

The first embodiment of this application discloses a method for live migration of a virtual machine, the flowchart of which is shown in FIG. 1. This method includes steps 110˜140.

Step 110, trapping an exception when an instruction of an instruction set that is not possessed by a destination host but possessed by a source host is executed in the virtual machine on the destination host. In one embodiment, the source host is a higher-generation processor than the destination host. For example, the source host is one generation higher than the destination host, the source host is a sixth-generation processor Skylake, and the instruction set of the source host is AVX512, while the destination host is a fifth-generation processor Broadwell, the instruction set of the destination host is AVX2. It should be understood that the source host may be a processor that is multiple generations higher than the destination host.
Step 120, intercepting the exception and analyzing an interrupt context of the exception by a kernel-based virtual machine module in the destination host.
Step 130, acquiring and decoding data of the instruction according to instruction address information in the interrupt context.
Step 140, emulating an execution process of the instructions by using an instruction set possessed by the destination host.

In one embodiment, the step of emulating the execution process of the instruction by using the instruction set of the destination host 140 further includes:
Step 1401, emulating a process of decoding the instruction by using a decoding tool, generating emulation instruction(s), and establishing a test case library;
Step 1402, transplanting the emulation instructions to the kernel-based virtual machine module in the destination host, and performing a regression test on the test case library.

In some embodiments, the decoding tool in step 1401 may be a third-party open-source or self-written binary decoding tool.

In one embodiment, the method further includes:
Step 150, creating a processor feature map in the destination host according to the emulation result;
Step 160, creating a virtual machine on the source host based on the processor feature map; and
Step 170, live-migrating the virtual machine on the source host to the destination host.

This application realizes the live migration of the virtual machine across different generation processors through the method of emulating instruction set, which slows down the period of the data center server obsolescence to a certain extent, thereby reducing the cost of server deployment.

In order to be able to better understand the technical solution of this specification, the following is an example of live migration of a virtual machine created based on an Intel Skylake processor to an Intel Broadwell processor. The details listed in this example are mainly for ease of understanding and are not intended to limit the scope of protection in this application.

In one embodiment, the KVM of the host operating system (host OS) on the Broadwell CPU is improved to support emulating the AVX512 instruction set architecture (Instruction Set Architecture, ISA). Referring to FIG. 2, the main process of emulating the AVX512 instruction set architecture includes four steps: Trap, Intercept, Decode, and Emulate. By emulating the Trap-Intercept-Decode-Emulate process of the AVX512 instruction set architecture, the AVX2 instructions that emulates the AVX512 instructions are generated, and the generated AVX2 instructions are added to the KVM of the Broadwell CPU, which is the process of improving the KVM. The specific steps of emulating the AVX512 instruction set architecture are as follows:
Trap: a virtual machine (VM) on the Broadwell CPU will trap a #UD exception when executing the AVX512 instruction;
Intercept: KVM intercepts the exception, and analyzes the interrupt context of the exception; Decode: through the instruction address information of the interrupt context, data of the instruction is acquired and decoded;
Emulate: the emulation process of the decoded AVX512 instruction is completed based on the AVX2 instructions.

The content acquired by decoding the interrupt context of the AVX512 instruction includes opcode and operands. During the emulation process of the AVX512 instruction set architecture, the opcode and operands of the AVX512 instruction that trapped the exception can be acquired, so as to determine which AVX512 instruction trapped the exception, what operations are used to complete, and what operands are involved. During the emulation process, the AVX2 instructions supported by the Broadwell CPU are used to complete this AVX512 instruction.

After that, the custom-model mode is formed on the Broadwell CPU. Based on the original Broadwell CPU features map, the processing capability characteristics of the AVX512 instruction enabled by the AVX2 emulation instructions are added to form a customized feature map, that is, the CPU feature map of “Broadwell+AVX512” is formed. Then, based on the custom-model mode, a virtual machine is created on the Skylake CPU, and the virtual machine on the Skylake CPU is live-migrated to the Broadwell CPU that has created a customized processor feature map. When the AVX512 instruction is executed in the virtual machine, the above Trap-Intercept-Decode-Emulate process can be triggered, and the emulation of the AVX512 instruction is completed.

In the deployment of specific data centers, firstly, a list of compatible server processor models is clearly sorted out to determine the difference in instruction sets of the cross-generation CPU involved in the list and specify the subset of instructions that need to be supported, thereby forming a CPU feature map for host-model mode on the destination host (i.e., the relatively low-generation processor).

In an embodiment, a third-party open-source or self-written binary decode tool is used to complete the emulation experiments of the required instructions in the user space and establish a comprehensive test case library. Then, the user space emulation instructions are transplanted into the kernel space KVM, and the above-mentioned test case library is used for regression testing. Using above customized host-model, virtual machines are created on cross generation CPU servers and the live migration operation is performed. The decoding tool is used to acquire the opcode and operands of the AVX512 instruction that caused the exception from the information in the exception context, so as to know which instruction the exception instruction is, what operation is completed, and which operands are involved. The decoding tool can be implemented in any decoding tools known in the art or known in the future, and they will not be repeated.

In the above embodiments, by emulating the AVX512 instruction set, the virtual machines created based on the Intel Skylake processor can be successfully live-migrated to the Intel Broadwell processor while retaining the AVX512 instruction set capability, thereby realizing the live migration of virtual machine across different generation processors.

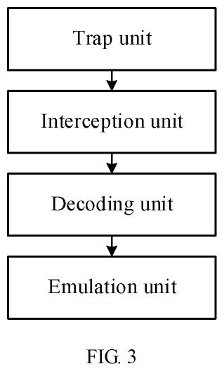

A second embodiment of this application discloses an apparatus for live migration of a virtual machine. FIG. 3 shows the schematic diagram of the apparatus. The apparatus includes a trap unit, an interception unit, a decoding unit, and an emulation unit.

The trap unit is configured to trap an exception when an instruction of an instruction set that is not possessed by a destination host but possessed by a source host is executed in the virtual machine on the destination host.

The interception unit is set in a kernel-based virtual machine module in the destination host, and configured to intercept the exception and analyze an interrupt context of the exception.

The decoding unit is configured to acquire and decode data of the instruction according to instruction address information of the interrupt context.

The emulation unit is configured to emulate an execution process of the instruction by using an instruction set possessed by the destination host.

In one embodiment, the apparatus also includes:
a creation unit, configured to create a processor feature map in the destination host according to the emulation results, and create a virtual machine on the source host based on the processor feature map; and
a migration unit, configured to live-migrate the virtual machine on the source host to the destination.

In one embodiment, when performing the step of emulating the execution process of the instruction by using the instruction set of the destination host, the emulation unit is further configured to:
emulate a process of decoding the instruction by using a decoding tool, generate emulation instruction(s), and establish a test case library; and
transplant the emulation instructions to the kernel-based virtual machine module in the destination host, and perform regression test on the test case library.

In one embodiment, the source host is a higher-generation processor than the destination host.

In one embodiment, the instruction set possessed by the destination host is AVX2, the instruction set possessed by the source host is AVX512. The first embodiment is a method embodiment corresponding to the present embodiment, and the technical details in the first embodiment can be applied to the present embodiment, and the technical details in the present embodiment can also be applied to the first embodiment.

It should be noted that technicians in the art should understand that the implementation function of the modules shown in the embodiments of the above apparatus for virtual machine live migration can be understood by referring to the relevant description of the aforementioned virtual machine live migration method. The functions of the modules shown in the embodiments of the above apparatus for virtual machine live migration can be implemented by the program (executable instructions) running on the processor, and can also be achieved through specific logical circuits. If the above apparatus for virtual machine live migration in the embodiment of this specification is implemented in the form of a software function module and as an independent product to be saled or used, it can also be stored in a computer-readable storage medium. Based on this understanding, the technical solutions of the embodiments of the present specification can be embodied in the form of software products in essence or part of contributions to the prior art. The computer software product is stored in a storage medium, and includes several instructions to enable a computer apparatus (which may be a personal computer, server, or network apparatus, etc.) to perform all or part of the methods described in the embodiments of the present specification. The foregoing storage media include various media that can store program codes, such as a U disk, a mobile hard disk, a read-only memory (ROM, Read Only Memory), a magnetic disk, or an optical disk. In this way, the embodiments of the present instruction are not limited to any specific combination of hardware and software.

It should be noted that in this specification of the application, relational terms such as the first and second, and so on are only configured to distinguish one entity or operation from another entity or operation, and do not necessarily require or imply any such actual relationship or order between these entities or operations. Furthermore, the term “comprises” or “comprising” or “includes” or any other variations thereof is intended to encompass a non-exclusive inclusion, such that a process, method, article, or apparatus that comprises multiple elements includes not only those elements but also other elements, or elements that are inherent to such a process, method, item, or apparatus. Without more restrictions, the element defined by the phrase “comprise(s) a/an” does not exclude that there are other identical elements in the process, method, item or apparatus that includes the element. In this specification of the application, if it is mentioned that an action is performed according to an element, it means the meaning of performing the action at least according to the element, and includes two cases: the action is performed only on the basis of the element, and the action is performed based on the element and other elements. Multiple, repeatedly, various, etc., expressions include 2, twice, 2 types, and 2 or more, twice or more, and 2 types or more types.

All documents mentioned in this specification are considered to be included in the disclosure of this application as a whole, so that they can be used as a basis for modification when necessary. In addition, it should be understood that the above descriptions are only preferred embodiments of this specification, and are not intended to limit the protection scope of this specification. Any modification, equivalent replacement, improvement, etc. made within the spirit and principle of one or more embodiments of this specification should be included in the protection scope of one or more embodiments of this specification.

In some cases, the actions or steps described in the claims can be performed in a different order than in the embodiments and still achieve desired results. In addition, the process described in the attachment does not necessarily require a specific order or continuous order to achieve the expected results. In some embodiments, multitasking and parallel processing are also possible or may be advantageous.

What is claimed is:

1. A method for live migration of a virtual machine, comprising:
trapping an exception when an instruction of an instruction set that is not possessed by a destination host but possessed by a source host is executed in a virtual machine on the destination host;
intercepting the exception and analyzing an interrupt context of the exception by a kernel-based virtual machine module in the destination host;
acquiring and decoding data of the instruction according to instruction address information in the interrupt context; and
emulating an execution process of the instruction by using an instruction set possessed by the destination host.

2. The method for live migration of a virtual machine according to claim 1, further comprising:
creating a processor feature map in the destination host according to the emulation results;
creating a virtual machine on the source host based on the processor feature map; and
live-migrating the virtual machine on the source host to the destination host.

3. The method for live migration of a virtual machine according to claim 1, wherein the step of emulating the execution process of the instruction by using the instruction set of the destination host, further comprising:
emulating a process of decoding the instruction by using a decoding tool, generating emulation instruction(s), and establishing a test case library; and
transplanting the emulation instructions to the kernel-based virtual machine module in the destination host, and performing regression test on the test case library.

4. The method for live migration of a virtual machine according to claim 1, wherein the source host is a higher-generation processor than the destination host.

5. The method for live migration of a virtual machine according to claim 1, wherein the instruction set possessed by the destination host is AVX2, and the instruction set possessed by the source host is AVX512.

6. An apparatus for live migration of a virtual machine, comprising:
a trap unit, configured to trap an exception when an instruction of an instruction set that is not possessed by a destination host but possessed by a source host is executed in the virtual machine on the destination host;
an interception unit, set in a kernel-based virtual machine module in the destination host, and configured to intercept the exception and analyze an interrupt context of the exception;
a decoding unit, configured to acquire and decode data of the instruction according to instruction address information of the interrupt context; and
an emulation unit, configured to emulate an execution process of the instruction by using an instruction set possessed by the destination host.

7. The apparatus for live migration of a virtual machine according to claim 6, further comprising:
a creation unit, configured to create a processor feature map in the destination host according to the emulation results, and create a virtual machine on the source host based on the processor feature map; and
a migration unit, configured to live-migrate the virtual machine on the source host to the destination.

8. The apparatus for live migration of a virtual machine according to claim 6, wherein when performing the step of emulating the execution process of the instruction by using the instruction set of the destination host, the emulation unit is further configured to:
emulate a process of decoding the instruction by using a decoding tool, generate emulation instruction(s), and establish a test case library; and
transplant the emulation instructions to the kernel-based virtual machine module in the destination host, and perform regression test on the test case library.

9. The apparatus for live migration of a virtual machine according to claim 6, wherein the source host is a higher-generation processor than the destination host.

10. The apparatus for live migration of a virtual machine according to claim 6, wherein the instruction set possessed by the destination host is AVX2, the instruction set possessed by the source host is AVX512.
